(19) United States
(12) Patent Application Publication
(10) Pub. No.: US 2007/0170014 A1
(43) Pub. Date: Jul. 26, 2007

(54) Device for moving a platform along elevator guide rails

(76) Inventor: Kenneth John Woronoff, Portland, CT (US)

Correspondence Address: David J Gaskey;Carlson Gaskey & Olds, Suite 350, 400 W Maple Road, Birmingham, MI, 48009, US

(21) Appl. No.: 10/588,938

(22) PCT Filed: Feb. 20, 2004
(86) PCT No.: PCT/US04/05145

§ 371 Date: Aug. 8, 2006

(51) Int. Cl. B66B 7/00

(52) U.S. Cl. 187/414

(57) ABSTRACT

This invention generally relates to an assembly (22) for moving a platform (28) along guide rails (24) within an elevator shaft during installation of an elevator system. The assembly includes a first platform (28), a first holding device (34), a second platform (30) and a second holding device (36). The holding devices operate to allow movement in one direction and restrict movement in an opposite direction. A moving mechanism (32) cyclically urges the first and second platforms toward and away from each other. The holding devices allow only one of the platforms to move at a time responsive to the cyclical urging of the moving mechanism. This is sequentially repeated until the first platform is in a desired position.

### FIELD OF THE INVENTION

This invention generally relates to a device for moving a platform along guide rails within an elevator shaft during installation of an elevator system.

### DESCRIPTION OF THE RELATED ART

Elevator systems typically include guide rails extending vertically in a hoistway to guide movement of the elevator car. A machine is supported near a top of the hoistway in a known manner. Typical installation procedures require using planking or platforms supported in the hoistway to provide access to various heights within the elevator shaft. Moving known platforms can be awkward and makes certain portions of the installation process difficult to complete.

An overhead crane or hoist is typically required to lift the platform, machine and other components to the required positions. Additionally, some structure supported by the building is often used as part of a safety hoist. Such measures increase costs and introduce delays for elevator system installation.

There is a need to provide a safer and easier method of moving items within a hoistway during the installation of the elevator system.

### SUMMARY OF THE INVENTION

In general terms, this invention is a device that improves moving items within a hoistway during elevator system installation.

One example installation assembly includes a first platform, a first holding device, a second platform and a second holding device. The first holding device maintains a vertical position of the first platform relative to a guide rail while permitting movement of the first platform in one direction. Likewise, the second holding device maintains a vertical position of the second platform relative to the guide rail while permitting movement in the same direction. The installation device also includes a moving mechanism associated with the platforms to incrementally move the platforms and holding devices.

In one example, the platforms are moved along the guide rail by cyclically urging the first and second platforms toward and away from each other. The holding devices allow the platforms to move in a desired direction and prevent movement in an opposite direction. In one embodiment, the movement includes securing the first platform in a first position, moving the second platform toward the first platform until the second platform is in a second position. Then securing the second platform in the second position; and moving the first platform away from the second platform to a new first position. These steps are sequentially repeated until the first platform is in a desired position.

These and other features of the present invention can be best understood from the following specification and drawings, of which the following is a brief description.

### BRIEF DESCRIPTION OF THE DRAWINGS

FIG. 1 schematically shows a general view of selected components of an elevator system with a moving device designed according to an embodiment of the present invention.

FIG. 2 is a schematic view of an example moving mechanism according to one embodiment of the present invention

FIG. 3a shows a roller safety device from one embodiment of the invention

FIG. 3b shows a wedge shaped safety device as from another embodiment of the invention

FIG. 4 schematically shows the position of platforms during the relative stages of operation of the example moving device.

FIG. 5 schematically shows another embodiment.

### DETAILED DESCRIPTION OF THE PREFERRED EMBODIMENT

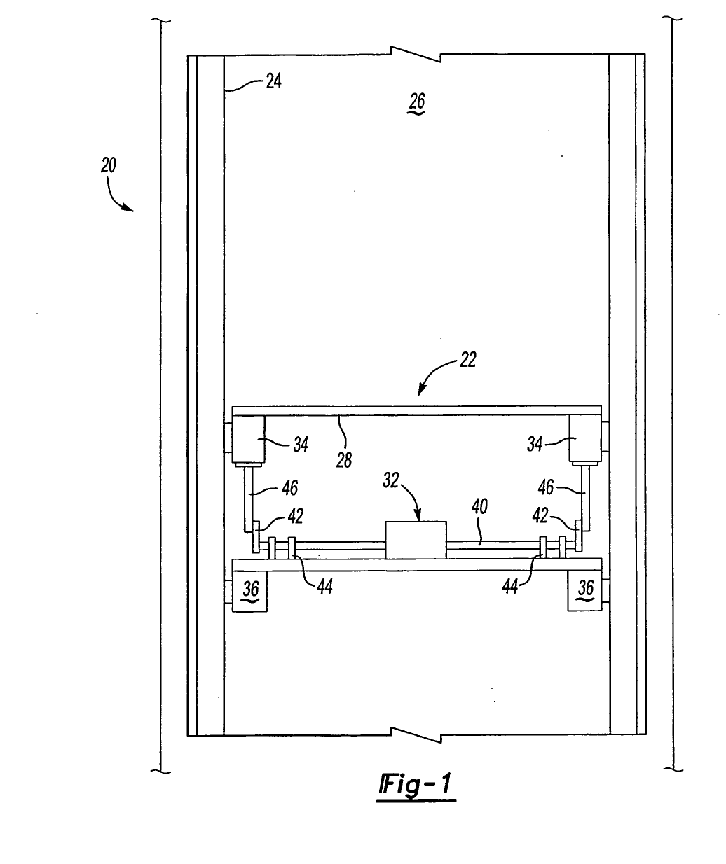

FIG. 1 illustrates portions of an elevator system 20 including an installation assembly 22. Guide rails 24 provide support and direction for the installation assembly 22 to move within a hoistway 26. The installation device assembly 22 includes at least a first platform 28 that is moveable along the guide rails 24. In one example, the first platform 28 is a temporary platform used during installation. In another example, the first platform 28 is part of an elevator car frame, such as the platform that eventually supports the floor of the cabin.

A second platform 30 is located below (according to the drawings) the first platform 28. The second platform 30 is generally parallel to the first platform 28. In one example, the second platform is a beam. A moving mechanism 32 is associated with the platforms and moves the first and second platforms 28 and 30 along the guide rails. In this example, portions of the moving mechanism 32 are mounted to the platform 30.

First holding devices 34 are fixed relative to the first platform 28. Second holding devices 36 are fixed to the second platform 30. The holding devices control movement of the platforms as described below.

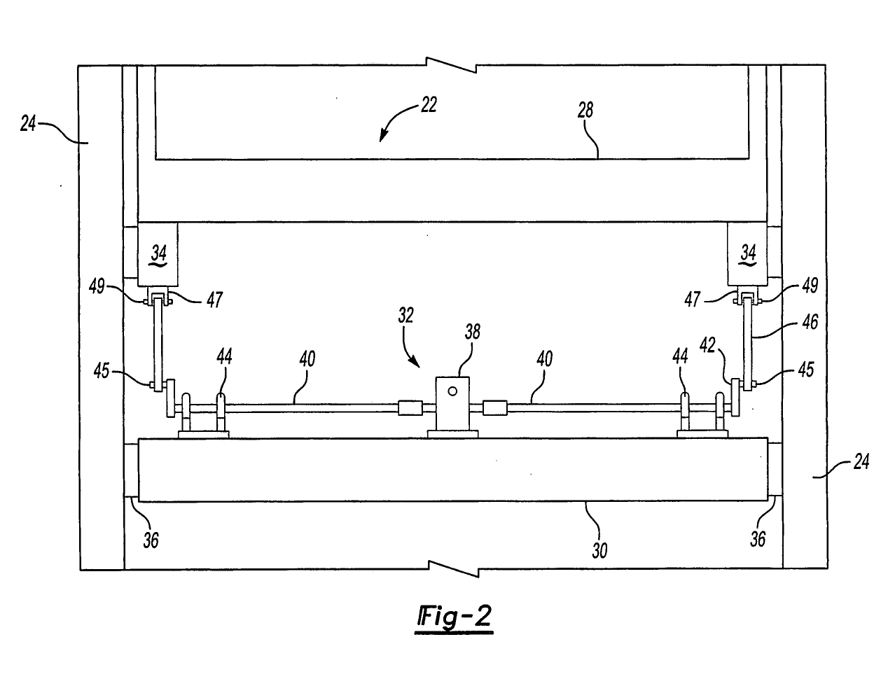

FIG. 2 shows a general view of the moving mechanism 32 of this example embodiment. The moving mechanism 32 includes a mover 38 attached to the second platform 30. The mover in this example includes a gear set (not shown) driven by a motor. In one example, a motor is provided as part of the moving mechanism 32. In another example, an outside motor such as that in a hand-held drill provides the motive force.

Driveshafts 40 extend from the mover 38 to levers 42. The driveshafts 40 are supported on the second platform by supports 44. The supports 44 allow the driveshafts 40 to rotate freely responsive to movement of the gear set in the mover 38. The driveshafts are non-rotatably connected to the levers 42. That is, as the driveshafts 40 rotate, the levers 42 rotate. In this example, the driveshafts 40 are connected to the levers 42 in an off-center position causing eccentric rotation of the levers 42.

The levers 42 are rotatably connected to linkage arms 46 by pins 45. An opposite end of the linkage arms 46 are associated with the first platform 28 in a manner to allow rotation of the linkage arms 46. In this example, each of the linkage arms 46 are connected to a holding device 34, which remains fixed relative to the first platform 28, by a connector 47 and a pin 49, as shown. The upper end of the linkage arms 46 will pivot on the pin 49 to correspond to the generally circular movement of the lower end of the linkage arms 46 caused by rotation of the levers 42.

The assembly 22 is shown in FIG. 2 in an extended position where the platforms 28 and 30 are spaced apart a maximum distance. In this position, the pins 45 are positioned vertically above the axes of the driveshafts 40. As the mover 38 rotates the driveshafts 40, the levers 42 rotate eccentrically and move the linkage arms 46. The eccentric rotation of the levers 42 cyclically urges the platforms toward and away from each other. For example, rotating the levers 42 from the position shown in FIG. 2 will move the pins 45 and the lower ends of the linkage arms 46 downward in an arcuate motion. As can be appreciated from the drawings, such motion increases or decreases the vertical spacing between the platforms 28 and 30.

The holding devices 34, 36 facilitate moving the platforms vertically along the guide rails 24 as the platforms are urged toward and away from each other. Before describing such movement, example holding devices are shown. In the illustrated examples, the holding devices maintain a vertical height and allow further upward movement responsive to operation of the moving mechanism 32.

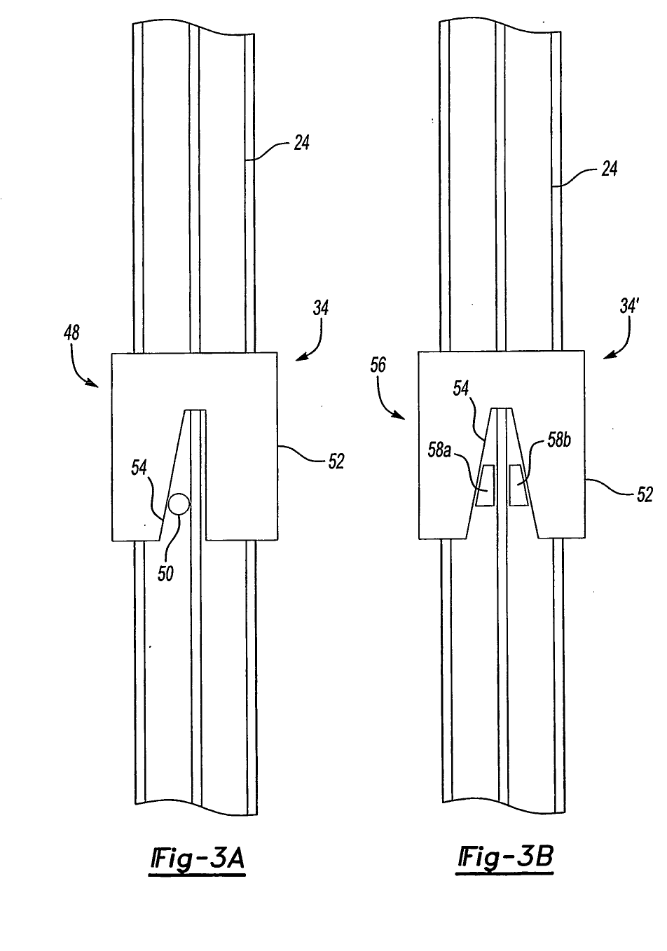

The holding devices may be known elevator safety devices of the type shown in FIGS. 3a and FIG. 3b. For example, FIG. 3a shows a roller safety device 48. The roller safety device 48 has a roller 50 which is associated with a safety block 52. The first or second platforms 28, 30 may be attached to the safety block 52. There is a wedge shaped opening 54 within the safety block 52. The roller 50 is positioned in the opening 54 between the safety block 52 and the guide rail 24. If the platform moves in a downward direction the roller 50 cooperates with the opening 54 and engages the guide rail 24 to restrict the roller from moving in a known manner. This allows the entire platform assembly to move downward only a short distance before the safety device stops such movement.

Alternately, FIG. 3b shows a wedge safety device 56. The wedge safety device 56 has two wedges 58a and 58b positioned around the guide rail 24. A wedge shaped opening 52 is again found in a safety block 52. If the platform secured to the safety block 52 moves in a downward direction, the wedges 58a and 58b cooperate with the opening 54 and engage the guide rail 24 in a known manner to restrict further movement. The platform is then stopped from further downward motion.

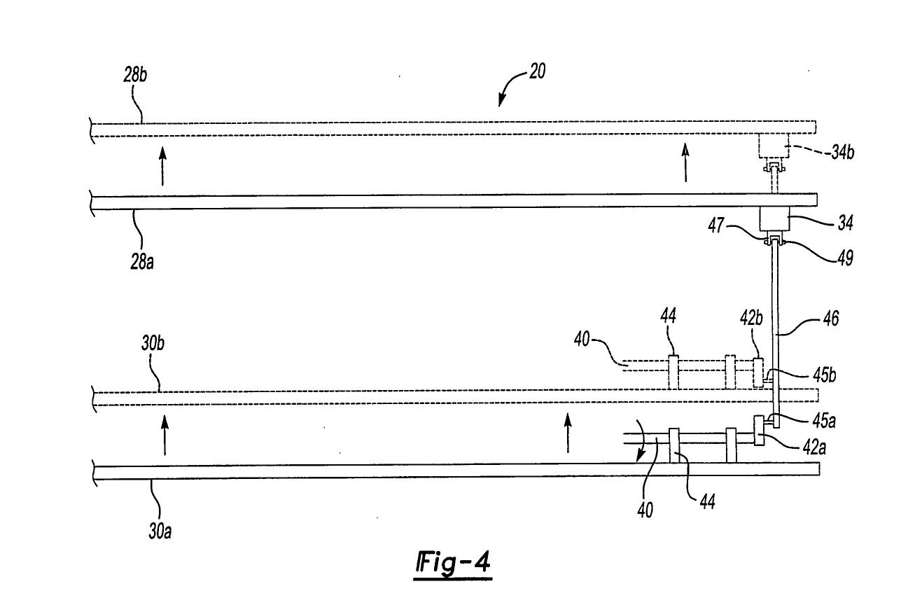

FIG. 4 only shows selected portions of the assembly 20 including the first platform 28 and the second platform 30 relative to one another. The first and second platforms are initially held in positions 28a and 30a, respectively, by the associated holding devices. The motion of the platforms can be described by starting with the linkage arms 46 in an extended position relative to the levers 42 (as shown in FIG. 2). The distance between the first platform 28 and the second platform 30 with this configuration of the moving mechanism components is at a maximum.

As the mover 38 rotates the driveshafts 40, the rotation of the levers 42 will cause the linkage arms 46 to begin a downward motion as the lower ends follow the pins 45 about the rotary path of the levers 42. This motion urges the platforms 28 and 30 toward each other. The first holding devices 34 restrict motion of the first platform 28 in a downward direction. As a result the linkage arms 46 effectively pull the second platform 30 upward to the position 30b. The upward pulling motion will continue until the linkage assemblies are in a contracted position (shown in phantom FIG. 4). The contracted position corresponds to the pins 45 on the levers 42 in a lower most position 45b relative to the axes of the driveshafts 40. When the linkage arms 46 are in a fully contracted position, the second platform is in position 30b. The first platform 28 remains in the original position 28a. The distance between the first platform 28 and the second platform 30 is then at a minimum (i.e., 28a and 30b).

Upon reaching the fully contracted position the levers 42 will continue rotating and the pins 45 will begin moving the linkage arms 46 back toward an extended position. This motion will urge the platforms 28 and 30 away from each other. As this occurs, the second holding devices 36 will prevent the second platform 30 from moving downward away from the position 30b. The first platform 28 then will be pushed upward by the movement of the linkage arms 46 until the first platform 28 reaches position 28b. At this point, the pins 45 are in an uppermost position relative to the axes of the driveshafts 40. The second platform 30 remains in position 30b because of holding devices 36. The alternate pulling and pushing of the first and second platforms can continue until the platform 28 reaches a desired position at which point the mover 38 is turned off (or an individual releases the trigger on a drill that is coupled to an appropriate portion of the mover, for example).

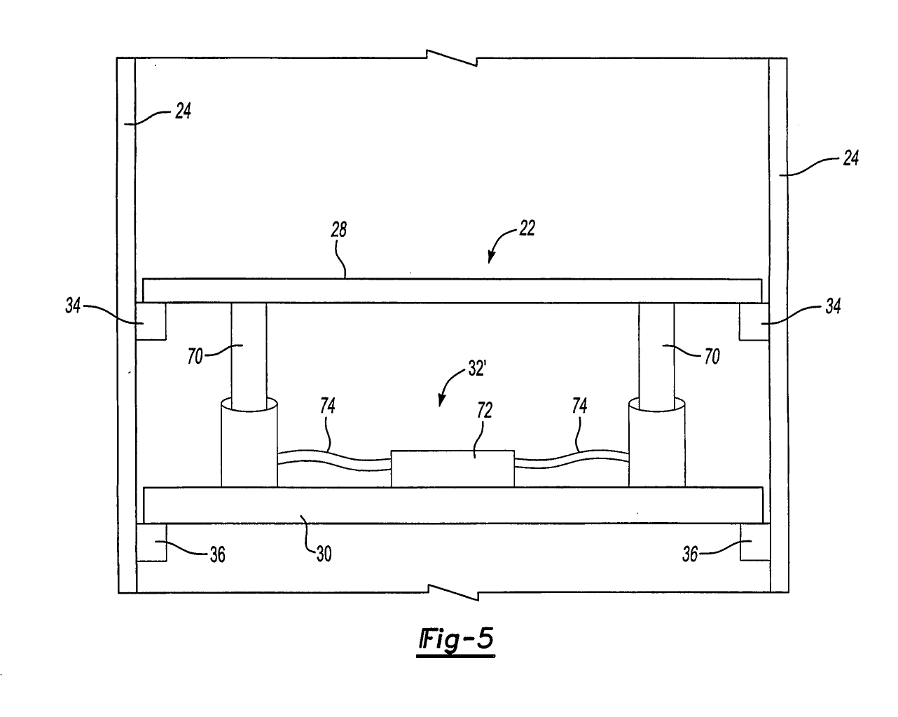

FIG. 5 schematically shows another example embodiment. In this example, the moving mechanism 32′ includes at least one pressurized actuator. In this example, two actuators 70 are shown. The pressurized actuator may be pneumatic or hydraulic, for example. A pressure source of pressurized fluid 72 is coupled using conventional fluid lines 74 to the actuator 70. By appropriately controlling the pressurized source 72, the actuator 70 expand and contract to cause the platforms 28 and 30 to move in a sequential manner because the holding devices 34 and 36 prevent downward movement (according to the drawing) of the platforms.

In an example where the moving mechanism 32′ is hydraulic, the pressure source 72 comprises a pump. In an example where the moving mechanism 32′ is pneumatic, the pressure source 72 comprises a compressor.

For example, when the actuator 70 are in an expanded position and fluid is evacuated from the actuators to cause them to contract, the second platform 30 is pulled upward toward the first platform 28. Subsequently, when the actuators are filled with pressurized fluid they expand causing the first platform 28 to be pushed upward and away from the second platform 30, which remains in position because of the operation of the holding devices 36.

Although preferred embodiments of this invention have been disclosed, a worker of ordinary skill in this art would recognize that certain modifications would come within the scope of this invention. For that reason, the following claims should be studied to determine the true scope and content of this invention.

1-17. (canceled)

18. An installation assembly for use with elevator systems, comprising;
a first platform;
a first holding device associated with the first platform, the first holding device having an operative position to maintain a vertical position of the first platform relative to a guide rail by preventing movement of the first platform in a first direction and permitting movement of the platform from the maintained position in an opposite direction;
a second platform;
a second holding device associated with the second platform, the second holding device having an operative position to maintain a vertical position of the second platform relative to the guide rail by preventing movement of the second platform in the first direction and permitting movement of the second platform from the maintained position in the opposite direction; and
a moving mechanism that incrementally moves the platforms in the one direction.

19. The assembly of claim 18, wherein the moving mechanism cyclically urges the first and second platforms toward and away from each other.

20. The assembly of claim 19, wherein the holding devices operate to allow only one of the first or second platforms to move at a time responsive to the urging of the moving mechanism.

21. The assembly of claim 18, wherein the moving mechanism includes a linkage assembly connected to the platforms for sequentially pushing the first platform away from the second platform in the one direction then pulling the second platform toward the first platform in the one direction.

22. The assembly of claim 21, where the linkage assembly comprises a rotatable drive shaft having a first end connected to a mover, a lever connected to an opposite end of the drive shaft, and a connecting link having a first end rotatably connected to the lever such that rotation of the drive shaft causes movement of the connecting link to push and pull the platforms away from and toward each other, respectively.

23. The assembly in claim 18, where the moving mechanism comprises a pressurized actuator.

24. The assembly of claim 18, wherein the first and second holding devices comprise elevator safety devices that are adapted to engage the guide rail to allow movement in the one direction and to prevent movement in the opposite direction

25. A device for moving a platform along guide rails in an elevator system, comprising:
a first platform;
a second platform; and
a moving mechanism between the first and second platforms and coupled to the platforms that sequentially urges the platforms toward and away from each other to cause incremental movement of the platforms in a desired direction along the guide rails, the moving mechanism includes at least one linkage arm that is moveable responsive to rotary movement of at least one other member to urge the platforms toward and away from each other.

26. The device of claim 25, including a holding device associated with each of the platforms, the holding devices allowing movement of the platforms along the guide rails in the desired direction and preventing movement of the platforms along the guide rails in an opposite direction.

27. The device of claim 25, wherein the at least one other member of the moving mechanism comprises a lever member coupled with the linkage arm such that rotary movement of the lever member causes generally linear movement of the linkage arm.

28. The device of claim 27, wherein the lever member is coupled to a rotatable drive shaft.

29. The device of claim 28, wherein the drive shaft and lever re supported on the second platform, one end of the linkage arm is coupled with the lever and an opposite end of the linkage arm is coupled with the first platform.

30. A device for moving a platform along guide rails in an elevator system, comprising:
a first platform;
a second platform; and
a moving mechanism comprising a pressurized actuator between the first and second platforms and coupled to the platforms that sequentially urges the platforms toward and away from each other to cause incremental movement of the platforms in a desired direction along the guide rails.

31. The device of claim 30, including a holding device associated with each of the platforms, the holding devices allowing movement of the platforms along the guide rails in the desired direction and preventing movement of the platforms along the guide rails in an opposite direction.
